(19) United States
(12) Patent Application Publication
(10) Pub. No.: US 2015/0123839 A1
(43) Pub. Date: May 7, 2015

(54) DEVICE FOR DETECTING AND LOCATING MOBILE BODIES PROVIDED WITH RADARS, AND RELATED METHOD

(71) Applicants: Jean-Michel Quellec, Ploumoguer (FR); Pascal Cornic, Guilers (FR); Daniel Jahan, Bohars (FR)

(72) Inventors: Jean-Michel Quellec, Ploumoguer (FR); Pascal Cornic, Guilers (FR); Daniel Jahan, Bohars (FR)

(73) Assignee: THALES, NEUILLY SUR SEINE (FR)

(21) Appl. No.: 14/348,025

(22) PCT Filed: Sep. 4, 2012
(86) PCT No.: PCT/EP2012/067232

§ 371 Date: Jul. 9, 2014

(30) Foreign Application Priority Data
Sep. 30, 2011 (FR) 1102963

(51) Int. Cl. G01S 7/02; G01S 7/04; G01S 13/06

(52) U.S. Cl. CPC G01S 7/02; G01S 13/06; G01S 7/04
USPC 342/146

(57) ABSTRACT

A device for detecting and locating moving objects that are equipped with at least one radar comprises a radar function comprising an antenna disposed on a revolving structure and a radar emissions detector function comprising an antennal part, and is characterized in that the antennal part of the radar emissions detector function is placed on said revolving structure.

The present invention relates notably to the field of maritime surveillance and more particularly to a device for detecting and locating moving objects that are equipped with at least one active radar.

Maritime surveillance can be performed on the basis of various platforms, such as for example, coastal stations, ships or aircraft. These surveillance platforms are always equipped with at least one radar and sometimes with radar detectors.

These sensors make it possible to detect and to locate the other platforms, naval or airborne, called targets. The aim is to search for the presence of undesirable targets or those in breach in the investigation area. The radar detects and locates the targets in its coverage area, through their illumination and the use of the power backscattered, or echoes, by them. The radar detector, for its part, detects and locates the targets in the environment, indirectly through the emissions of their radars, accordingly it is obviously necessary that the latter be active.

Generally, to cover the angular domain of interest, the antenna of the radar performs a 360° scan in bearing and, while the radar antenna is sweeping toward the target, the radar measures the distance between it and the target by measuring the delay time between the emission and the reception of the radar signal. The radar also measures the bearing of the target by measuring the antenna bearing for which the backscattered signal is a maximum.

The target is thus located in terms of distance and azimuth, with respect to the position of the platform, as soon as the antenna sweeps across the target. With each sweep of the radar antenna across the target, the position of the latter is refreshed. This refreshing makes it possible to follow the progress of the target and allows its tracking. However, the fact, with regard to the radar, of emitting in a continuous manner is not always necessary, especially if the targets are not very mobile or do not change trajectory, this being the case for ships. Moreover, the fact of emitting in a continuous manner may allow the radar detectors of the other platforms to detect and locate the presence of the surveillance platform equipped with these radars, and to identify it. The excessive use of the radar is therefore indiscreet.

When the surveillance platform is equipped with a radar detector, the former comprises, in general, a set of antennas making it possible to instantaneously cover the 360° surveillance domain in bearing. This set of antennas can be formed, for example, by 6 antennas each pointed every 60° in terms of bearing. The installation also comprises a box having the functions of reception, analysis, tracking and identification of the radar emissions received over a wide frequency range, such as for example, between 0.5 and 18 GHz.

This type of sensor is characterized by an instantaneous reception both over 360° of bearing and over a very wide frequency band. The consequence is a low antenna gain, generally not exceeding a few dBi. This low antenna gain, associated with non-optimal conditions of signal detection, renders the interception of radars at low radiated peak power (radars with so-called Low Probability of Intercept or LPI) impossible at distances of operational interest. This is still more true for a maritime surveillance aircraft which possesses horizons in relation to its flight altitudes. Thus the detection of radars, with so-called low probability of intercept, is not easy on the sweep of their main lobe and is still less so on their diffuse lobe, thereby considerably limiting the possibility of detecting them.

Another problem with equipment of this type originates from the viewing of the results on the screens of the radar and of the radar detector. Indeed, when the platform is equipped both with a radar and with a radar detector, the radar uses a superimposable representation that can be overlaid on a geographical map of the area, and the radar detector uses a representation, generally in azimuth-frequency cartesian coordinates. These two representations do not allow a global mode of presentation since they are not superimposed.

An electronic support measures (or ESM) system comprising a radar and a passive receiver is also known in the prior art, such as for example through the Japanese patent application published under the number JP 2001 264 420.

The invention is aimed at correcting all or part of the aforementioned problems by proposing a device making it possible to increase the gain of the antennas of the radar detectors.

For this purpose, the subject of the invention is a device for detecting and locating moving objects that are equipped with at least one radar, said device comprising a radar function comprising an antenna disposed on a revolving structure and a radar emission detector function comprising an antennal part, the device being characterized in that the antennal part of said radar emissions detector function is placed on said revolving structure.

According to a particular feature of the invention, the antennal part of the radar emissions detector function, of the device, is formed of at least one array of antennas delivering as many signals in parallel as there are antennas, together these signals allowing goniometry on a single radar pulse (monopulse processing).

According to another particular feature, the antennal part of the radar emissions detector function is an interferometry array.

According to another particular feature, the device comprises at least one transmission system between its fixed part and its rotating part and a signals concentration system able to transpose the signals received by the various antennas on a limited number of pathways so as to be transmitted through the transmission system.

According to another particular feature, the device comprises a control module able to rotate the revolving structure so as to perform an azimuthal scan, by the group of antennas of the radar emissions detector function, over at least one revolution, so as to locate, in an approximate manner, at least one target radar present in the scan area of the device.

According to another particular feature, the control module, of the device, is able to orient the antenna group of the radar emission detector function in the direction of a target radar which is tagged subsequent to the azimuthal scan, so as to determine the precise azimuth of said target radar.

According to another particular feature, the control module of the device is able to orient the antennal part of the radar emission detector function in the direction of a target radar which is tagged subsequent to the azimuthal scan, so as to determine the precise scan law of said target radar.

According to another particular feature, the device comprises a control module able to rotate the revolving structure so as to perform an azimuthal scan, by the radar antennal part of the radar function, over at least one revolution, so as to locate, in an approximate manner, at least one platform equipped with at least one target radar present in the scan area of the device and then to orient the antennal part of the radar emissions detector function in the direction of a tagged target radar so as to determine the precise azimuth of said target radar as well as its scan law.

According to another particular feature, the device comprises a viewing system comprising a graphical module able to display a graphical representation of each target radar by a half-line having, as origin, the position of the moving object detecting and locating device in the graphical representation, and making an angle, with respect to the North direction, equal to the measured azimuth.

According to another particular feature, the graphical module makes it possible to represent each target radar by a half-line of different color or nature.

According to another particular feature, the device viewing system is arranged so as to display the graphical representations of the target radars identified superimposed with a map obtained during the usage of the radar part.

The main advantages of the invention are notably those of allowing an increase in the gain of the antennas of the radar detectors and an integrated viewing, based on the superposition of the contacts arising from the radar detection and those arising from the radar emission detector. The invention also makes it possible to reduce the radar emission time of moving object detecting and locating devices and therefore greater discretion.

Other particular features and advantages of the present invention will become more clearly apparent on reading the description hereinafter, given by way of nonlimiting illustration and with reference to the appended drawings, in which:

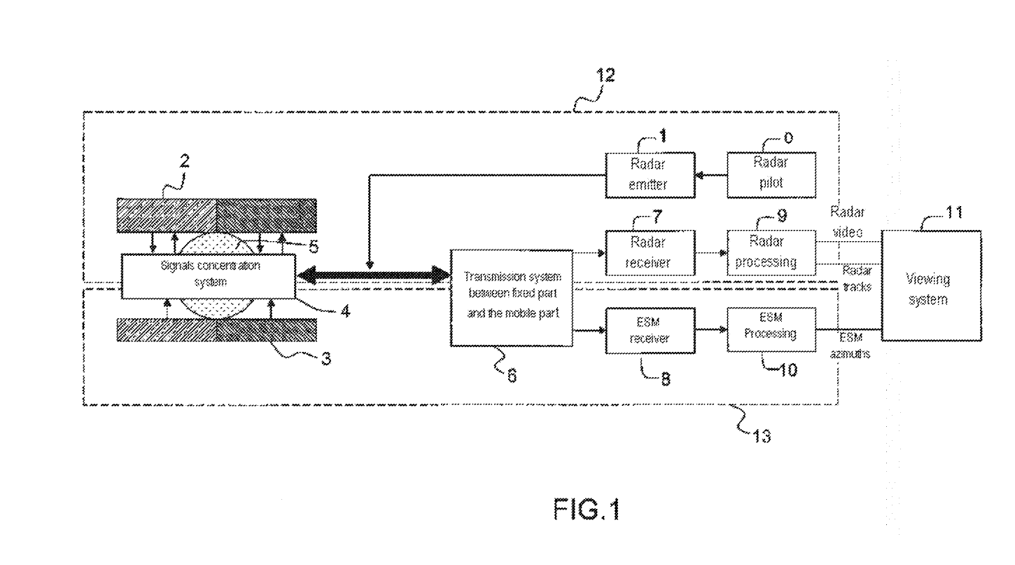

FIG. 1 represents a functional diagram of an exemplary embodiment of the device according to the invention.

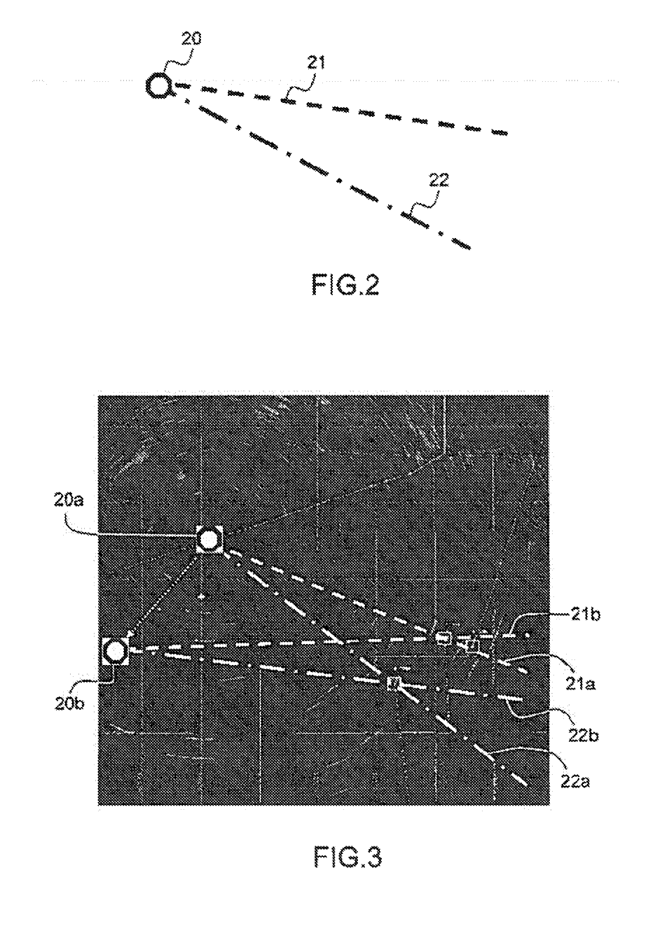

FIG. 2 represents an exemplary display, on a viewing device, of the results of a search with the aid of the device according to the invention.

FIG. 3 represents an exemplary display, on a viewing device, of the results of a search with the aid of the equipment of the radar function and radar detector function of the device according to the invention.

The present invention relates to a device for detecting and locating moving objects that are equipped with at least one radar. This device may, for example, be on the ground or onboard a mobile platform, such as for example, an aircraft or a ship.

It should be noted that subsequently the radar detector will be designated by the initials ESM for “Electronic Support Measure”.

FIG. 1 presents an exemplary embodiment of a device for detecting and locating moving objects according to the invention. This device integrates two functions, a radar function 12 and an ESM function 13. The antenna 2, of the radar function 12, is mounted on a revolving structure 5 of the device.

According to an exemplary embodiment, an antenna function can be carried out on the basis of a linear combination of the signals arising from a set of elementary antennas or radiating elements, one then speaks of beam formation. The latter may be more or less complicated, fixed or electronically adjustable.

The device according to the invention comprises at least, a pilot 0, a radar emitter 1, an antenna system 2, 3, a radar receiver 7, an ESM receiver 8, a radar processing unit 9, an ESM processing unit 10 and a viewing system 11.

According to a particular feature of the invention, the ESM antennal part 3 is mounted on the revolving structure 5 of the device. In an advantageous manner, placing the ESM antennal part 3 in the space left free for the progress of the revolving structure 5 of the radar antenna and the large dimensions of these radar antennas offer the possibility of using larger ESM antennas than those customarily used today.

According to an embodiment, the ESM antennal part 3 is placed on the same side as the radar antenna 2, that is to say with a radiation in the same direction or in substantially neighboring directions. So that their radiation does not get in each other's way, the antennal parts 2, 3 are placed in a substantially vertical plane, one above the other, or one alongside the other. According to another embodiment, the ESM antennal part 3 is placed on the side opposite from the radiating face of the radar antenna 2, in such a way that their radiation occurs in substantially opposite directions.

The composition of the ESM antennal part 3 depends on the frequency bands corresponding to the radars of the targets sought and bulkiness constraints.

In an advantageous manner, the invention makes it possible to use the volume on the carrier, customarily dedicated to the revolving radar to also carry out an ESM function. In particular, it makes it possible to exploit the structure of the revolving antenna of the device so as to supplement same with judiciously placed ESM antennas.

Moreover, fitting the ESM antennal part 3 on the revolving structure of the device avoids multiplication of the antennas in terms of bearing and makes it possible to house ESM antennas that are relatively large in relation to the wavelengths used. The advantage of this is to afford the ESM antennal part 3 much more gain, thus improving the sensitivity of the device and therefore the detectability of the signals of low radiated peak power.

In an advantageous manner, the invention also allows easier integration, on the carrier platform, of the ESM device since the ESM antennal part 3 is installed in the scan volume of the radar antenna 2.

According to a particular feature of the invention, the antennal parts 2 and 3 can use respectively several antennas so as to perform goniometries on a single pulse.

According to an exemplary embodiment, the antennal part 3 of the ESM function 13 is formed of at least one array of antennas delivering as many signals in parallel as there are antennas. This array of several antennas, by delivering a set of signals carrying the information and the precision that are sought on a single pulse, allows instantaneous goniometry on a single radar pulse, also called monopulse processing. This set of antennas, or array of goniometry antennas, can give rise to processings of a distribution of power or of amplitude in the case of amplitude goniometry, of a phase distribution in the case of processing by interferometry, or of an arrival time distribution (or TDOA, for Time Difference Of Arrival).

According to a particular embodiment, illustrated in FIG. 1, the ESM function uses an antennal part formed of two panels of antennas, one so-called “right” and the other so-called “left”. These two panels, delivering two signals in parallel, make it possible to carry out simple and very precise goniometry on a single pulse.

We recall that a panel of antennas is formed of plane radiating arrays of elements possessing beam formation synthesizing the equivalent of a single antenna.

In other embodiments, the antennal part 3 of the ESM function 13 is an interferometry array.

A difficulty, in the field of radar detection, is the wide frequency band to be covered. A solution can consist in splitting this frequency band into various sub-bands. This may culminate in hardware means dedicated to each of the sub-bands. For example, in the case of panel antennas, a specific panel can be dedicated to each sub-band.

In order to transmit the signals between the fixed part and the mobile part of the device for detecting and locating moving objects, the latter comprises a transmission system between these two parts. This transmission system can, for example, be a swivel joint for high-frequency signals or a revolving collector for low-frequency signals.

The signals of the various pathways of the ESM antennal part 3 as well as optionally the signals arising from the radar antenna 2, when the latter is not emitting, are separated and dispatched to a signals concentration system 4.

This signals concentration system 4 consists in making the signals received on the various antennal parts 2, 3 pass along a limited number of pathways that is compatible with the transmission system 6.

According to an embodiment, the signals of the various pathways of each ESM antenna 3 are transposed to a different frequency channel by effecting the mixing of the signals with different oscillators whose frequencies are tiered so as to be able to make the concentrated signal, containing the signals received, pass along a single pathway of the transmission system 6.

At the output of the transmission system 6, bandpass filters make it possible to separate the signals and to retrieve the signals arising from the various antennas.

According to another embodiment, the transmission system 6 is a, for example high-bitrate, digital optical swivel joint. In order to transmit the signals through this collector, the signals received on the various antennas are transposed to baseband and coded in digital by the concentration system 4.

The signals output by the transmission system 6 are thereafter filtered so as to retrieve the signals arising from each of the antennas, in order to be processed respectively by a radar receiver 7 and a radar processing module 9 and an ESM receiver 8 and an ESM processing module 10.

According to an embodiment, the passbands of the antennas of the ESM antennal part 3 are not chosen wide so as to be able to detect all possible radars, but are chosen narrower and in relation to the range of the frequencies of the radars sought. The chosen frequency bands may, for example, be the X and S bands.

The detection and location of moving objects equipped with at least one radar is effected mainly in two steps. Initially, the control module of the device sets its system of antennas 2, 3, into rotation over at least one revolution, so as to locate the target radars approximately, and then subsequently the device determines in a precise manner the azimuth of the detected targets. According to an exemplary implementation, this rotation can be limited to one revolution.

According to a first mode of implementation, location of the target radars is performed only by the ESM function 13, the radar function 12 not being active. Accordingly, the control module of the device sets the revolving structure 5 of the device into rotation so as to perform an azimuthal scan of the area to be kept under surveillance by the ESM antennal part 3.

During the rotation of the mobile structure 5, the reception module 8 and the ESM processing module 10 catalog the various radar emissions present in the scan area of the device according to the conventional techniques of ESM functions.

According to a particular feature of the invention, the high gain of the ESM antennas 3 allows the ESM function 13 as a whole to acquire the radar emissions equally well on their main lobe and on their diffuse lobes.

During the rotation, when a radar emission has been intercepted by the ESM function, its ESM processing 10 searches for the instant for which the radar emission is directed toward the ESM function. This is done by analyzing the signal power delivered by the ESM antennal part 3.

Reception on the main lobe of the target radar makes it possible to improve the knowledge of the base parameters of the detected target radar such as for example, its pulse width, its pulse repetition period, its emission frequency. Reception on several main lobes in succession makes it possible to determine the rotation period of the antenna of the target radar and its scan law.

Subsequent to the scanning of the area to be kept under surveillance by the ESM antennal part 3, the target radars are located approximately in terms of azimuth and the scan law of their antenna is known.

Subsequently, by virtue of the information gathered during the azimuthal scan step, the ESM device will refine the azimuthal location of the various target radars detected.

Accordingly, the control module of the detection and location device orients the revolving structure 5 so as to point the ESM antennal part 3 temporarily in the direction of a target radar to be located at the instant of presumed sweeping of the main lobe of the antenna, of said target radar, in the direction of the detection device.

In so far as the ESM antennas 3 are structured into frequency sub-bands, the frequency of the target radar to be located being known, the ESM device selects the antennal part of the sub-band corresponding to the emission frequency of the target radar.

In so far as the ESM antennas 3 are antennal panels offering a directivity with a main lobe, when the latter receives the main lobe of the antenna of the target radar, the ESM processing module 10 calculates the precise azimuth of the emission of the target radar by using monopulse processing, such as for example and in a nonlimiting manner, by deviometry or by interferometry. This calculation is performed on the basis of the signals received from the various antennas constituting said panel, and by using a reception filter and an integrator corresponding to the previously established characteristics of the target radar. The emission of the target radar being located in terms of azimuth, so also is the carrier platform of this target radar.

The azimuth of the target radar, being determined in a precise manner, can serve to establish a graphical representation on the viewing device 11, such as for example a screen. In order to facilitate utilization, the graphical representations of the target radars can be overlaid on a geographical map of the area scanned by the device or a map of the area to be kept under surveillance.

With reference to FIG. 2, according to an exemplary embodiment, the viewing system 11 possesses a graphical module able to display a graphical representation of each target radar, represented by a half-line 21a, 21b having as origin the position of the device for detecting and locating moving objects on the geographical map and making an angle, with respect to the North direction, equal to the precise azimuth of the target radar measured.

According to a particular feature of the invention, the graphical module of the viewing system 11 is arranged so as to display each target radar located with a graphical representation of different color. According to another embodiment, the display of the half-lines representing the various target radars is of a different nature, such as for example, a single or double line, a solid, dotted or dashed line or any other equivalent form.

So as not to overload the image presented, the operator can deselect the display of certain target radars. Accordingly, the viewing device 11 can possess means of control of the display of the graphical representations of the detected target radars. The operator can thus restrict the display to just the detected target radars of interest to him.

The viewing system 11 can also comprise a memory area able to store the position of the target radars, measured during previous searches. The viewing system 11 can thus display the half-lines corresponding to the position of a target radar at various instants and thus follow the displacement of the carrier platform of this target radar.

With reference to FIG. 3, when the detection and location device is onboard a mobile platform, such as for example a ship or an aircraft, each half-line 21a, 21b or 22a, 22b, representing the same radar at different instants, has a different origin 20a, 20b. In this case, it is possible, by a triangulation operation, to view the estimated position 210, 220 of the target radar and to calculate the distance between this target radar and the radar detection and location device.

The precision of this triangulation operation is related to the angular slewing of the carrier of the detection and location device with respect to the target radar; the greater this slewing, the better the precision. Consequently, one will search for a displacement of the carrier of the detection and location device which is fast with respect to the target, and courses which are not merged and fairly transverse.

Moreover, to be able to perform this viewing, it is preferable that the map, displayed on the viewing device, be referenced with respect to a fixed frame on the ground.

In an advantageous manner, this triangulation operation can make it possible to dispense with the step of determining the target radar precise azimuth.

According to another embodiment, location of the carrier platforms of the target radars can be performed by the radar function 12 of the detection and location device and then the precise azimuth of each radar, of the located carrier platforms, can be determined by the ESM part 13 of the device.

In this mode of implementation, the operating principle consists in initializing a tactical situation by the radar part 12 of the device and thereafter in sustaining this tactical situation in passive terms by the ESM part 13 of the device.

Initially, an azimuthal scan of the area to be kept under surveillance is carried out by the radar part 12 of the detection and location device. Accordingly, the control module of the device sets the revolving structure 5 into rotation over at least one revolution in such a way that the revolving antenna 2 scans the area to be kept under surveillance so as to locate the target platforms present in the scan area.

According to a preferential mode of implementation, the rotation is limited to one revolution so as to limit the emission time of the radar antenna 2 and thus minimize the detectability of the detection and location device.

Once the positions of these platforms are known the search and the analysis is continued, in a passive manner, by the ESM function 13 of the device. The control module of the radar detection and location device sets the revolving structure 5 into rotation so as to orient the group of ESM antennas 3 temporarily in the direction of a target radar detected during the radar scan.

The ESM part 13 will thereafter measure the various parameters of the target radar, such as for example, the values of pulse width, of pulse repetition period and of pulse frequency of the radar emission. This part will also refine the measurement of the azimuth of this target radar.

Once the various parameters are known, the viewing of the targets, on a viewing device, can be carried out, as described previously, by half-lines. FIG. 3 presents an exemplary display of a radar screen in which the graphical representations, of the target radars analyzed by the ESM part, appear superimposed with the radar map of the targets detected during the phase of use of the radar part 12.

In the case where the device according to the invention is onboard a mobile platform, the viewing of the target radars can be superimposed with the map of the radar tracks extrapolated on the basis of the end of the radar emission. The operator can thus see, without emitting, whether the positions obtained by ESM triangulation do or do not diverge with respect to the extrapolated radar position of the target. The operator can thus decide whether or not to repeat a temporary radar emission so as to refresh the positions of the targets obtained by this means.

1. A device for detecting and locating moving objects comprising at least one radar, said device comprising: a radar function comprising an antenna disposed on a revolving structure and a radar emission detector function comprising an antennal part, said antennal part of said radar emissions detector function being placed on said revolving structure.

2. The device as claimed in claim 1, in which the antennal part of the radar emissions detector function is formed of at least one array of antennas delivering as many signals in parallel as there are antennas, together these signals allowing goniometry on a single radar pulse (monopulse processing).

3. The device as claimed in claim 1, in which the antennal part of the radar emissions detector function is an interferometry array.

4. The device as claimed in claim 1, in which said device comprises at least one transmission system between its fixed part and its rotating part and a signals concentration system able to transpose the signals received by the various antennas on a limited number of pathways so as to be transmitted through the transmission system.

5. The device as claimed in claim 1, in which said device comprises a control module able to rotate the revolving structure so as to perform an azimuthal scan, by the group of antennas of the radar emissions detector function, over at least one revolution, so as to locate, in an approximate manner, at least one target radar present in the scan area of the device.

6. The device as claimed in claim 5, in which the control module is able to orient the antenna group of the radar emission detector function in the direction of a target radar which is tagged subsequent to the azimuthal scan, so as to determine the precise azimuth of said target radar.

7. The device as claimed in claim 5, in which the control module is able to orient the antennal part of the radar emission detector function in the direction of a target radar which is tagged subsequent to the azimuthal scan, so as to determine the precise scan law of said target radar.

8. The device as claimed in claim 1, in which said device comprises a control module able to rotate the revolving structure so as to perform an azimuthal scan, by the radar antennal part of the radar function, over at least one revolution, so as to locate, in an approximate manner, at least one platform equipped with at least one target radar present in the scan area of the device and then to orient the antennal part of the radar emissions detector function in the direction of a tagged target radar so as to determine the precise azimuth of said target radar as well as its scan law.

9. The device as claimed in claim 1, in which said device comprises a viewing system comprising a graphical module able to display a graphical representation of each target radar by a half-line having, as origin, the position of the moving object detecting and locating device in the graphical representation, and making an angle, with respect to the North direction, equal to the measured azimuth.

10. The device as claimed in claim 9, in which the graphical module makes it possible to represent each target radar by a half-line of different color or different nature.

11. Device according to claim 9, in which the viewing system is arranged so as to display the graphical representations of the target radars identified superimposed with a map obtained during the usage of the radar part.
